(19) United States
(12) Patent Application Publication
(10) Pub. No.: US 2019/0309457 A1
(43) Pub. Date: Oct. 10, 2019

(54) Low-emission melamine formaldehyde nonwovens and nonwoven materials

(71) Applicant: Ostthüringische Materialprüfgesellschaft für Textil und Kunststoffe mbH, Rudolstadt (DE)

(72) Inventors: Christoph KINDLER, Saalfeld (DE); Yvonne EWERT, Rudolstadt (DE)

(21) Appl. No.: 16/340,188

(22) PCT Filed: Oct. 11, 2017
(86) PCT No.: PCT/EP2017/075949

§ 371 Date: Apr. 8, 2019

(30) Foreign Application Priority Data
Oct. 11, 2016 (DE) 10 2016 012 034.7

(51) Int. Cl. D04H 3/009; D04H 1/4326; D04H 1/56; D04H 3/16

(52) U.S. Cl. CPC D04H 3/009; D04H 1/4326; C08G 12/32; D04H 3/16; D04H 1/56

(57) ABSTRACT

Melamine-formaldehyde-based nonwovens or nonwoven materials and methods for the production thereof are provided. Melamine formaldehyde resin with a low formaldehyde fraction, preferably with virtually complete etherification of the methylol groups with methanol, is used. The resin is spun via a melt-blow process, with a mass flow melt per nozzle of 0.3 to 3.0 g/min. A gas stream at a temperature of 130 to 330° C. flows at the mass flow melt. The formed fibers and/or flakes are laid to form a nonwoven material and treated with gaseous HCl, followed by thermal treatment in which air flows at or through the nonwoven material to increase heat transfer. The temperature is raised in stages to 260 to 340° C. The material is then kept at temperature for 5 to 90 minutes, followed by rapid cooling. The nonwovens or nonwoven materials are suitable as thermal insulators or sound insulation material.

The present invention relates to heat- and flame-resistant textile nonwovens or nonwoven fabrics comprising fibers/flocs consisting of thermoset melamine-formaldehyde. They are suitable as thermal insulator and as acoustic insulation material, and exhibit a feature that is not typical for this type of material: low emission of volatile organic compounds, in particular formaldehyde. The formaldehyde emissions of the low-emission melamine/formaldehyde nonwovens and melamine/formaldehyde nonwoven fabrics are significantly lower than the threshold values.

The production of melamine-resin nonwovens by the melt-blow process is claimed in general terms in dependent claim 29 in WO 2006/100041 A1.

The melt-blow process uses hot air emerging from a die together with the melt to lengthen the resultant filaments and to spin these to give particularly fine final fibers. These fibers are laid to give a random-laid composite, then the resultant spunbonded nonwoven is prehardened with use of gaseous HCl and then its hardening reaction is completed at high temperatures.

WO 2013/152858 A1 describes microfiber nonwovens made of fibrous flocs made of reactive low-molecular-weight resin melts which are capable of forming polymers and have solidified in the form of glasses. The diameter of the individual fibers here is less than 5 μm.

WO 2014/080003 describes a melamine/formaldehyde foam with particulate fill material and reduced formaldehyde values (determined in accordance with DIN 55666).

EP 2 616 505 B1 describes a process for the production of a melamine/formaldehyde foam with improved hydrolysis resistance.

This leads to low formaldehyde emissions at elevated temperature and moisture levels. Heat-conditioning and passage of hot air through the material are used here to achieve the following formaldehyde emission values:

<150 mg/kg in accordance with VDA 275
<40 mg/kg in accordance with DIN EN ISO 14184-1
<0.03 mg/kg in accordance with DIN 717-1.

No thermoset material based on formaldehyde has been disclosed hitherto that complies with the requirements of the automobile industry for the interior. In accordance with VDA 275, this requires formaldehyde values below 10 mg/kg.

It was an aim of the present invention to develop a textile sheet whose fibers consist essentially, i.e. to an extent of from 70 to 100% by weight, of duromers based on melamine/formaldehyde. This textile sheet is intended to comply with the requirements of the automobile industry for the interior in relation to formaldehyde emissions, and to exhibit values significantly lower than the currently applicable threshold values, so that it can continue in use in the event of possible future tightening of the threshold values in this sector.

Extensive experimentation has revealed that use of hot air flowing onto or through a material can produce a low-emission textile sheet with density less than 1.00 kg/m³, preferably with density from 5 to 20 kg/m³, and with high resilience. A progressive temperature profile is to be selected here, and the air flowing through the material must be replaced at least to some extent by fresh air. The requirements of the automobile industry in relation to formaldehyde emissions for the interior are met, and the values obtained are significantly below the currently applicable threshold values.

Raw material used comprises a melamine-formaldehyde resin in accordance with DE102006027760 with low formaldehyde content, preferably with M:F ratio 1:2, and with almost complete etherification of the methylol groups by methanol, i.e. at least 80% of methylol groups have been etherified.

The material is produced as described in WO 2013/152858 A1. The textile sheet is produced here via melting of solid, methanol-etherified melamine-formaldehyde resins followed by spinning by way of a melt-blow process. A melt stream here produced by melt dies arranged in a row alongside one another on a spinning beam is molded in a plurality of steps to give a large number of microfibers/flocs. The molten raw material here is taken up by a hot air stream with temperature above the melt temperature, fluidized, fibrized and layered in a laying system to give a nonwoven fabric.

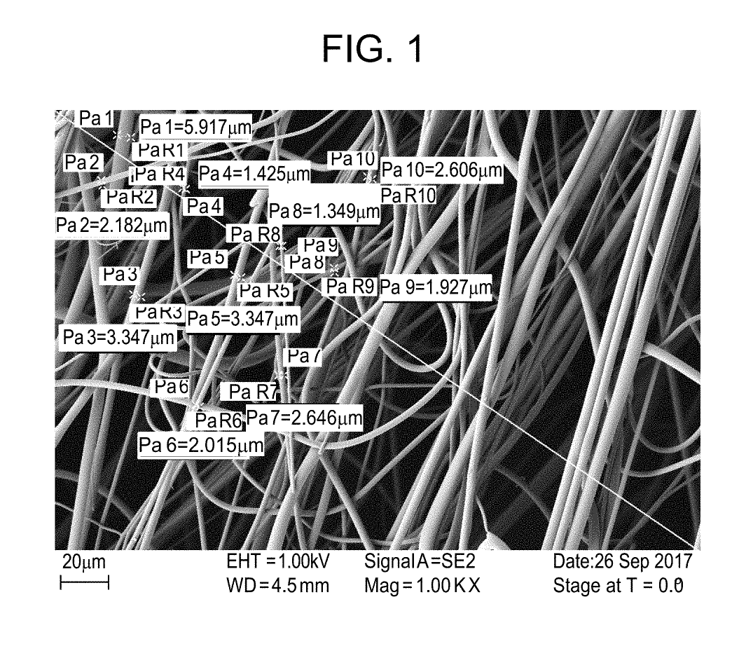

Preferred process conditions are a mass flow rate of the melt of 0.3 to 3.0 g/min per die, preferably from 0.85 to 1.5 g/min, a melt temperature of from 80 to 200° C., particularly preferably about 160° C., and a gas stream temperature of from 130 to 330° C., particularly preferably about 310° C. The aim is to obtain structures of maximal fineness with average fiber diameters less than 10 μm, preferably less than 5 μm, and with maximized surface:volume ratio. Spinning processes used here are of the type described in WO 2013/152858 or WO 2006/100041. This gives sheets consisting of very fine individual fibers and/or flocs as depicted in FIG. 1.

Collection of the resultant flocs or fibers can alternatively be achieved by adjusting the angle between die and laying area to be smaller than 90°, or the laying area can have a convex or concave surface. Air can be removed by suction below the perforated laying area. After collection on the laying area, the nonwoven or the nonwoven fabric has been cooled to from 40 to 20° C., i.e. to about room temperature.

It is thus possible to achieve densities of from 5 to 20 kg/m³ that are of interest for lightweight applications, as thermal insulator and as acoustic insulation material.

The nonwoven or the nonwoven fabric is then treated with hydrogen chloride gas. The gas treatment advantageously takes place in a sealed chamber, preferably at room temperature. After exposure to hydrogen chloride, the material has significantly higher reactivity. In another process step, the nonwoven or nonwoven fabric is subjected to a thermal treatment. For this, the temperature is increased continuously or gradually to from 260 to 340° C., preferably to from 260 to 320° C. The permitted temperature increase here in the range up to 160° C. for the stabilization of the structure is only at most 20° C./min. Once 160° C. has been reached, the temperature rise can be increased to 100° C./min. The nonwoven or the nonwoven fabric is then kept at the temperature reached, up to 340° C., for from 5 to 90 min, preferably for from 10 to 60 min. During the entire thermal treatment, hot air flows through or onto the material in order to improve heat transfer. From 5 to 50% of the convection air must be replaced by fresh air during the procedure.

Once the thermal treatment has concluded, rapid cooling of the hot material to from 30 to 60° C., preferably from 30 to 40° C., is imposed within a period of 5 s and at most 3 min, preferably within a period of from 20 s to 2 min, by contact with material suitable for rapid heat exchange, for example laying on a metal belt and use of cold air at a temperature of from 0° C. to 40° C. flowing through the material.

The final product is characterized by a mass per unit area in the range from 20 to 600 g/m², the thickness of the material being up to 40 mm. The resultant low densities, and the voluminosity, provide particular acoustic and thermal properties to the final product. The heat- and flame-resistant nonwoven and, respectively, the nonwoven fabric, produced by the process described, is part of the present invention.

Resultant thermal conductivity values (in accordance with DIN EN ISO 8302) are low: from 0.028 W/(m*K) to 0.030 W/(m*K), depending on mass per unit area, fiber fineness, thickness, degree of compaction and post-treatment.

The structure of the nonwoven, and the particularly fine fibers, moreover permit construction of a nonwoven providing effective acoustic insulation. The acoustic properties are listed by way of example in the following table (in accordance with DIN ISO 10534-2; test sample diameter: 30 mm):

### EXAMPLE 1: SPUNBONDED MELAMINE RESIN NONWOVEN 03/16-2T (MASS PER UNIT AREA: 400 G/M²; AVERAGE FIBER DIAMETER: 3.8 μM; THICKNESS: 19.3 MM)

MER 03-16-2 T OS absorption

| Frequency [Hz] | Absorption |
|---|---|
| 1000 | 0.454 |
| 1250 | 0.586 |
| 1600 | 0.721 |
| 2000 | 0.84 |
| 2500 | 0.922 |
| 3150 | 0.971 |
| 4000 | 0.989 |
| 5000 | 0.984 |

### EXAMPLE 2: SPUNBONDED MELAMINE RESIN NONWOVEN 26/16-1T (MASS PER UNIT AREA: 300 G/M²; AVERAGE FIBER DIAMETER: 3.0 μM; THICKNESS: 15.3 MM)

MER 26-16-1 T OS absorption

| Frequency [Hz] | Absorption |
|---|---|
| 1000 | 0.224 |
| 1250 | 0.331 |
| 1600 | 0.473 |
| 2000 | 0.621 |
| 2500 | 0.757 |
| 3150 | 0.874 |
| 4000 | 0.952 |
| 5000 | 0.99 |

Achievement of the low formaldehyde emissions in the product requires the combination of the following building blocks:
Use of a low-formaldehyde-content starting resin.
Spinning of very fine structures with fiber diameters below 10 μm, preferably <5 μm, and largest possible surface area:volume ratio.
Use of high melt temperatures and blown air temperatures in order to remove a portion of the formaldehyde at an early stage through the onset of the polycondensation reaction during the spinning process.
A subsequent thermal treatment during which by way of example air is caused to flow onto or through the material in order to increase heat transfer. The volume flow rate here must be very uniform. The convection air is replaced to some extent here by fresh air.

The resultant nonwoven melamine-formaldehyde fabrics were subjected to the following tests to determine formaldehyde emissions:
DIN EN ISO 14184-1 Textiles—Determination of formaldehyde—Part 1: Free and hydrolysed formaldehyde (water extraction method)
VDA 275 Determination of formaldehyde emission. Moldings for vehicle interiors—Determination of formaldehyde emission
The threshold value is currently 10 mg/kg

These test methods differ in principle in the conditions to which the material is subjected and in the methods used.

In the case of DIN EN ISO 14184-1, the quantity of formaldehyde that can be liberated is determined at a temperature of 40° C. in an aqueous medium.

The test arrangement in accordance with VDA 275 suspends the test sample above water for three hours at 60° C., and the emissions are collected and then quantitatively analyzed.

Emission of formaldehyde occurs with all products based on thermoset formaldehyde compounds, because formaldehyde is a constituent, or the main constituent of the material.

However, many tests were carried out in the region of room temperatures and body temperatures, because these are the traditional usage temperatures of many materials and components.

Formaldehyde emission increases with increasing temperature and humidity. The emission values are exponentially dependent on the test temperature. This relationship can be described approximately by the empirical Arrhenius equation.

The low-emission nonwoven melamine/formaldehyde fabrics produced by the process described above achieve the following values:
DIN EN ISO 14184-1: values obtained are below the threshold value of 16 mg/kg
VDA 275: 3.6 mg/kg
VDA 277: 28 μgC/g
VDA 278: <1 mg/kg VOC; <1 mg/kg FOG
DIN 75201-B: 0 mg
Japan Law 112: <16 mg/kg, meeting the requirements for Oeko-Tex class 1.

The resultant sheet material is preferably used as thermal insulator and as acoustic insulation material, in particular for lightweight applications, and also in vehicle construction and the transport industry.

1. A process for the production of heat- and flame-resistant, low-emission nonwovens or nonwoven fabrics based on melamine/formaldehyde, comprising the following stages:
a) melting a melamine/formaldehyde resin with low formaldehyde content;
b) spinning the melt at a mass flow rate of from 0.3 to 3.0 g/min per die at a melt temperature of from 80 to 200° C.;
c) causing a gas stream at a temperature of from 130 to 330° C. to flow onto the spun melt stream to form flocs and/or fibers;
d) laying the flocs and/or fibers formed in stage c) to make a nonwoven or nonwoven fabric, with cooling;
e) treating the nonwoven or nonwoven fabric with gaseous hydrogen chloride;
f) heating the nonwoven or nonwoven fabric obtained in stage e) to from 260 to 340° C., and causing air flow onto or through said nonwoven or nonwoven fabric, wherein the temperature is increased by at most 20° C./min in the range up to 160° C. and thereafter is increased by up to 100° C./min;
g) keeping of the nonwoven or nonwoven fabric at the temperature reached in stage f) for from 5 to 90 min, and partially replacing the convected air by fresh air; and
h) cooling of the nonwoven or nonwoven fabric to from 30 to 60° C. within from 5 s to 3 min.

2. The process as claimed in claim 1, wherein said method further comprises replacing from 5% to 50% of the convection air with fresh air in the process stages 1f) and 1g).

3. A heat- and flame-resistant nonwoven or nonwoven fabric comprising melamine/formaldehyde as claimed in claim 1.

4. The nonwoven or nonwoven fabric as claimed in claim 3, wherein said nonwoven or nonwoven fabric has a formaldehyde emission of 5 mg/kg or less when measured in accordance with VDA 275, and/or is less than 16 mg/kg when measured in accordance with Japan Law 112.

5. The nonwoven or nonwoven fabric as claimed in claim 3, wherein said nonwoven or nonwoven fabric has a density of less than 100 kg/m³.

6. The nonwoven or nonwoven fabric as claimed in claim 5, wherein said nonwoven or nonwoven fabric has a diameter of individual components of less than 10 μm.

7. The nonwoven or nonwoven fabric as claimed in claim 3, wherein said nonwoven or nonwoven fabric achieves thermal conductivity values below 0.030 W/(m*K) measured in accordance with DIN EN ISO 8302.

8. The nonwoven or nonwoven fabric as claimed in claim 3, wherein said nonwoven or nonwoven fabric achieves acoustic adsorption values above 0.6 at 2000 Hz measured in accordance with DIN ISO 10534-2 for test sample diameter 30 mm.

9. Thermal insulator or as acoustic insulation material comprising nonwoven or nonwoven fabric as claimed in claim 3.

10. A process for the production of heat- and flame-resistant, low-emission nonwovens or nonwoven fabrics as claimed in claim 1, wherein said melamine/formaldehyde resin has an M:F ratio 1:2, with almost complete etherification of the methylol groups with methanol.

11. The nonwoven or nonwoven fabric as claimed in claim 5, wherein said density is from 5 to 50 kg/m³.

12. The nonwoven or nonwoven fabric as claimed in claim 5, wherein said density is from 5 to 35 kg/m³.

13. The nonwoven or nonwoven fabric as claimed in claim 6, wherein the diameter of the individual components is less than 5 μm.
